(19) United States
(12) Patent Application Publication
(10) Pub. No.: US 2010/0118643 A1
(43) Pub. Date: May 13, 2010

(54) AGITATOR FOR ABRASIVE MEDIA

(75) Inventor: Wolfgang Keller, Kembs (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: EKATO Rühr- und Mischtechnik GmbH, Schopfheim (DE)

(21) Appl. No.: 12/598,698

(22) PCT Filed: Apr. 30, 2008
(86) PCT No.: PCT/EP2008/003522

§ 371 Date: Nov. 3, 2009

(30) Foreign Application Priority Data
May 4, 2007 (DE) 10 2007 021 056.8

(51) Int. Cl. B01F 13/00

(52) U.S. Cl. 366/343

(57) ABSTRACT

Disclosed is a agitator (1; 1a-1h), particularly for abrasive media, comprising a support disk (2; 2a-2h) to which agitator blades (3; 3a-3h) are connected substantially perpendicular to the support disk (2; 2a-2h), said blades (3; 3a-3h) being arranged substantially in a radial direction. The support disk (2; 2a-2h) is also provided with a hub that receives an agitator shaft which is preferably motor-driven in a suitable manner. The trailing faces of the blades (3; 3a-3h) of the agitator (1; 1a-1h) and/or the area of the blade connections to the support disk (2; 2a-2h) is/are designed to largely prevent vortex shedding. For this purpose, preferred geometrical measures for the agitator blades (3; 3a-3h), the support disk (2; 2a-2h), and the connection of the blades (3; 3a-3h) to the support disk (2; 2a-2h) are disclosed and described.

The invention relates to an agitator which is particularly intended for abrasive media. Increased wear due to abrasion occurs when abrasive media are stirred, such as suspensions with high concentrations of solid matter which may occur, for example, when processing ore in, for example, oxidation autoclaves for refining gold and copper, so that the agitator has only relatively short operating times before it must be replaced.

Attempts have been made to apply coatings of abrasion-resistant materials, for example hard metals, metal carbides or the like, on the agitators for reducing abrasion. Such coatings are not only extremely expensive, but application of the coatings can also partially weaken the support material, which may cause additional problems. Extremely corrosive conditions are present particularly when processing ore using wet-chemical processes, which necessitates the use of particularly resistant materials, such as titanium compositions, for the support material. However, such coatings which improve the wear resistance frequently do not exhibit sufficient chemical resistance, so that they can be removed by corrosion.

So-called disk agitators represent one particular type of radially conveying agitator; disk agitators include a support disk to which several agitator blades are attached. The agitator blades are attached to the support disk in a substantially perpendicular and radial direction. The support disk in this type of disk agitator is oriented substantially horizontally, and the agitator blades are attached to the support disk at about half the blade height. Disk agitators having this design can have a different number of agitator blades and/or the agitator blades can have blade surfaces of different sizes.

It is an object of the invention to provide an agitator, in particular for abrasive media, with a support disk, wherein agitator blades are attached to the support disk in a substantially vertical and substantially radial direction relative to the support disk, and which has a hub for receiving an agitator shaft, wherein the agitator is designed to resist abrasion and has a longer operating time when used as designed.

According to the invention, an agitator, in particular for abrasive media, with a support disk is provided, to which agitator blades are attached in a substantially perpendicular and substantially radial direction relative to the support disk, and which has a hub for receiving an agitator shaft, wherein the agitator is characterized in that the sides of the agitator blades and/or the region of the blade attachment to the support disk are formed so as to substantially prevent vortex shedding.

With the agitator of the invention, the geometry of the agitator is selected and adjusted in the region of the support disk, of the agitator blade, of the agitator blade attachment and of the agitator hub or the like so as to reduce abrasion and improve the operating time, with the result that the wear characteristic due to abrasion can be significantly reduced or even completely eliminated even when the abrasive media have high concentrations of solid matter, a large applied agitator power and high circumferential speeds. The geometry of the agitator of the invention hereby is changed and optimized to attain agitators which have longer operating times, thus reducing maintenance and replacement intervals of the agitators, so that facility downtimes can be significantly shortened.

Preferably, for a design which effectively prevents vortex shedding, the respective agitator blade has a pitch angle β with respect to the radial direction from about 10° to 60°, preferably from about 20° to 50°. This prevents shedding of vortices on the agitator blades, thereby improving the flow pattern around the blades and hence also significantly improving the abrasion resistance of the agitator.

According to a preferred alternative embodiment of the invention, the geometry of the agitator blade is constructed so as to substantially prevent vortex shedding, i.e., the geometry of the agitator blade itself is optimized, particularly on the side facing away from the flow. This reduces or prevents impact and sliding abrasion on the trailing end of the agitator blades, so that such agitator becomes more wear resistant.

According to a preferred embodiment of the invention, the respective agitator blade has a radius (R) in the region where the blade is attached to the support disk, with the radius facing the flow direction. This radius R has preferably a value of R=(0.1−1.0)×diameter of the agitator. Changing the shape of the respective agitator blades can more effectively prevent vortex shedding, wherein extremely advantageous and wear-resistant flow patterns around the blades are obtained particularly in combination with a corresponding pitch of the agitator blades in the radial direction having the aforementioned angular ranges.

According to an alternative or additional embodiment, the agitator blades of the agitator of the invention may be attached with one side on the support disk, so that the support disk protects the agitator blades against impact and sliding wear particularly in the trailing edge region. Optionally, not only the shape of the support disk can be altered in a suitable manner, but also the number of the support disk parts or support disk elements, whereby the support disk may preferably be designed to substantially prevent vortex shedding in the attachment region of the agitator blades, and/or the support disk may include several support disk parts.

According to an alternative or additional preferred embodiment of the invention, the support disk may include a recess on the side of the agitator blades facing away from the flow, for reducing the wear surface for the abrasive effects on the support disk and on the attachment location of the agitator blades.

According to a preferred embodiment of the invention, a flow around the agitator blades with unfavorable vortex formation can be prevented by arranging wing-shaped elements on the inner edge of the agitator blades.

Optionally, the agitator blade may be completely or at least partially coated with an abrasion-resistant material at those locations that are at risk of being abraded. This can further improve the operating time and the resilience of such agitator even under extremely severe operating conditions.

In summary, it is important for the agitator according to the invention that improvements are attained with the help of geometric means at those locations that are at risk of being abraded, e.g., the sides of the agitator blades facing away from the flow and/or in the regions where the blade is attached to the support disk, which result in a design that is substantially free from vortex shedding. With these measures, in particular impact and sliding wear can be substantially reduced when such agitator is used as intended, in particular a radial conveyor in form of a disk agitator, and the operating times of such agitator can be improved without requiring additional time-consuming and expensive measures on the agitator, such as coatings and the like. With the solutions according to the invention, in particular those measures are proposed which allow a reduction of vortex shedding which is detrimental for the wear characteristic and establish more advantageous flow conditions around the blades, without adversely affecting the basic efficiency of such agitator. The invention can suppress the wear mechanism by altering the shape of the agitator, producing an agitator with extended operating times and significant savings for maintenance and system downtimes. It will be understood that the agitator with the improved geometry should not have a lower efficiency.

The invention will now be described in more detail with reference to preferred embodiments which are not to be viewed as limiting, and with reference to the appended drawing. In the drawings, the embodiments of the agitators are illustrated in a corresponding FIG. in a top view and underneath in a side view. In the drawing:

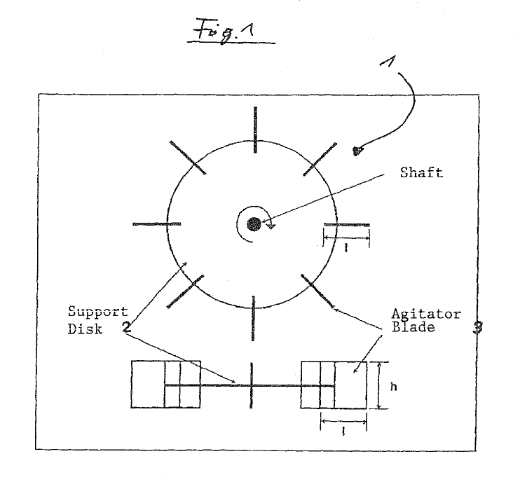

FIG. 1 shows a conventional embodiment of an agitator in the form of a radially conveying disk agitator;

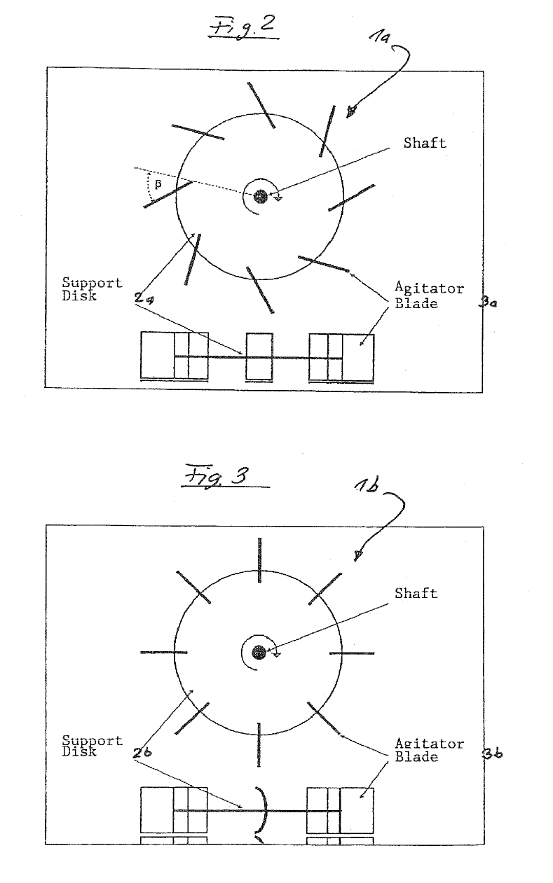

FIG. 2 shows an embodiment of a shape of an agitator according to the invention in a first preferred embodiment;

FIG. 3 shows another embodiment of an agitator according to the invention with a changed blade shape of the agitator blades;

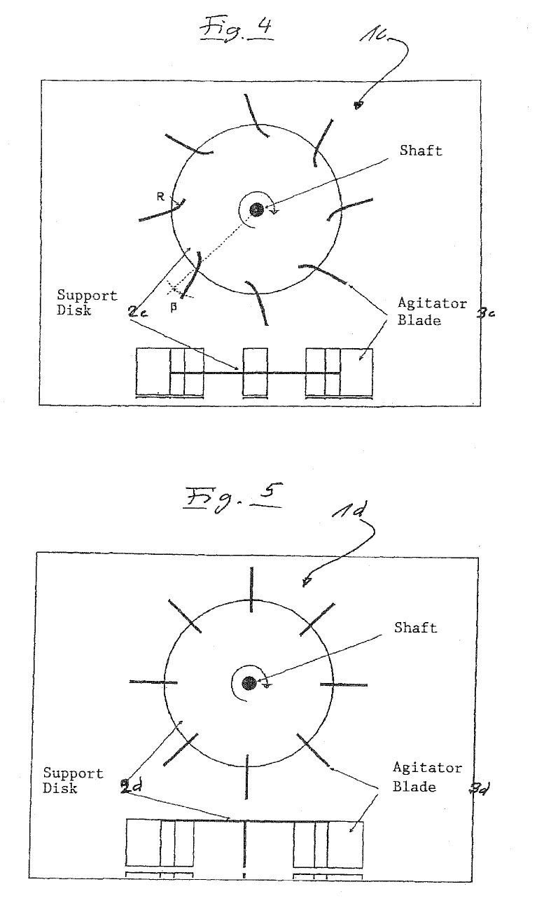

FIG. 4 shows another preferred embodiment with a changed blade shape and a pitch of the agitator blades in the radial direction;

FIG. 5 shows another embodiment of the agitator according to the invention with a changed attachment of the agitator blades on the support disk;

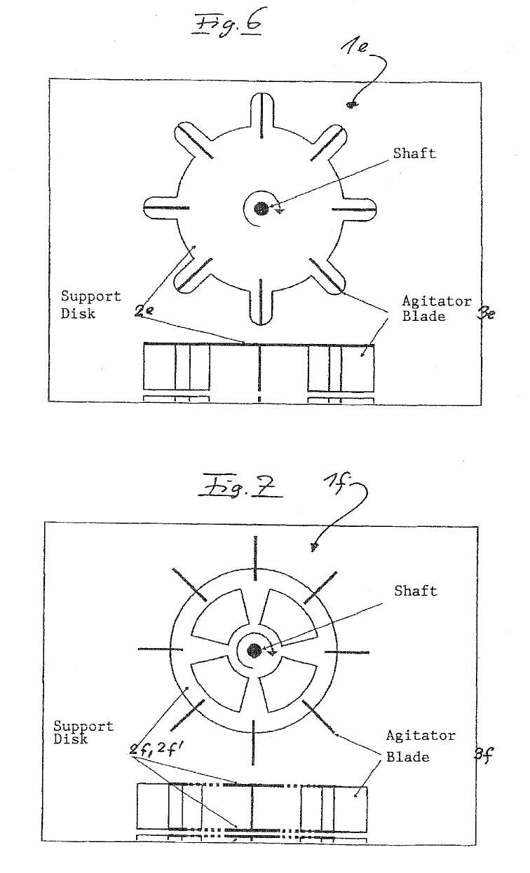

FIG. 6 shows another embodiment of the agitator according to the invention with a changed embodiment of a support disk;

FIG. 7 shows another embodiment of the agitator according to the invention with a modified design of the support disk;

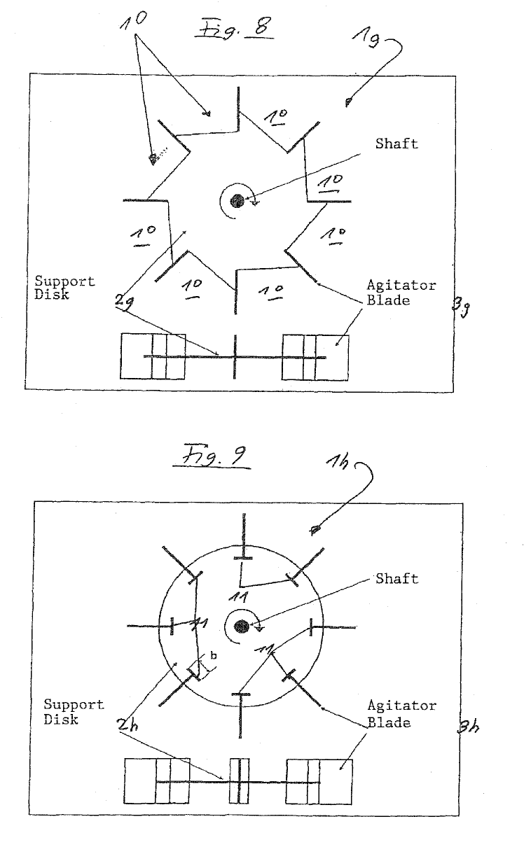

FIG. 8 shows an alternative preferred embodiment of an agitator according to the invention with a partially modified support disk and optimized attachment points of the agitator blades on the support disk; and

FIG. 9 shows another preferred embodiment of an agitator according to the invention with additional measures for improving the flow around the agitator blades on the inside edge of a blade.

The rotation direction of the agitator shaft and hence of the support disk are indicated in the figures of the drawings by an arrow.

In addition, if applicable, identical or similar elements are indicated in the figures of the drawings with identical reference symbols.

FIG. 1 shows in a schematic diagram an exemplary radially conveying agitator, a so-called disk agitator of conventional design. The agitator designated with the reference symbol 1 includes a preferably horizontally oriented support disk 2, with several agitator blades 3 attached to the support disk 2 perpendicular and in a substantially radial direction. In the illustrated embodiment, the agitator blades 3 are straight and have a rectangular shape. The agitator blades 3 are arranged symmetrical about the circumference of the support disk 2. Each rectangular agitator blade 3 has a height h and a length l. In the illustrated example, the agitator blades 3 are attached on the support disk 2 at about half the blade height h. Such agitator 1 has a favorable dispersing effect, in particular with gas flow, and produces a primarily radial flow direction with a corresponding pumping efficiency and a substantial gas dispersing ability

FIGS. 2 to 9 show particularly preferred geometric modifications of such agitator according to the invention. It is important that this agitator design of the invention with modified geometry shows no detrimental effects, either with respect to the primary flow direction, the pumping efficiency, the applied power or the gas dispersing ability.

In the configuration of the agitator 1a according to the invention illustrated in FIG. 2, the agitator blades 3a have a pitch angle β with respect to the radial direction, which is in the range of about 10° to 50°, preferably in a range from about 20° to 50°. With this radial pitch angle of the agitator blades 3a, vortex shedding, in particular on the trailing side of the agitator blades 3, can be prevented, so that the agitator 1a exhibits more advantageous flow conditions in the region of the agitator blades 3a and where the agitator blades 3a are attached to the support disk 2a.

In the configuration of the agitator 1a according to FIG. 3, the blade shape of the agitator blades 3a is optimized and changed accordingly, as can be seen more clearly from the bottom diagram in FIG. 3. With a corresponding design of the agitator blades 3b, vortex shedding can be prevented and more advantageous flow conditions around the agitator blades 3b and the associated attachment regions of the agitator blades 3b on the support disk 2b can be attained.

FIG. 4 shows an embodiment of an agitator 1c, where the agitator blades 3c, like in FIG. 2, are oriented at a pitch angle β relative to the radial direction, wherein for improving the flow around the blades and for preventing vortex shedding the agitator blades 3c have a radius R in the attachment region on the support disk 2c, which is preferably in a range of R=(0.1−1.0)×diameter of the agitator. The diameter of the agitator is the largest outside diameter of the agitator 1c, including the outermost ends of the agitator blades 3c.

FIGS. 5 to 7 describe modified embodiments of agitators 1d to 1f, wherein the respective agitator blades 3d to 3f are attached with one side on the associated support disk 2d to 2f. The corresponding support disk 2d to 2f forms a cover for the attached agitator blades 3d to 3f, thereby preventing flow around the agitator blades 3d to 3f. In the embodiment of FIG. 5, radially arranged agitator blades 3d, which are substantially oriented in the radial direction, are attached on an end face of the support disk 2d.

In the embodiment of the agitator 1e according to FIG. 6, the shape and in particular the outside contour of the support disk 2e is changed and adapted, and at the same time, the agitator blades 3e are attached substantially radially with one side of the support disk 2e. This produces an advantageous effect similar to that of the embodiment of FIG. 5.

In the modified embodiment according to FIG. 7, the agitator 1f has several support disk parts 2f and 2f′, which in combination form the support disk. These two support disk parts 2f and 2f′ each form the outside contour of the agitator 1f as seen in the axial direction, wherein both sides of the agitator blades 3f are attached to and covered by the support disk parts 2f and 2f′. This also helps to prevent wear-producing flow around the agitator blades 3f.

Accordingly, FIGS. 5 to 7 show embodiments of agitators 1d to 1f where, on one hand, the shape of the support disk 2e (shown in FIG. 6) or, on the other hand, the number of support disk parts 2f, 2f′ (see FIG. 7) are varied.

FIG. 8 shows a modified embodiment of an agitator 1g, wherein the geometry and the size of the support disk 2g are changed. Recesses 10 are provided on the support disk 2g on the side of the agitator blades 3g facing away from the flow, thereby reducing the area of the wear surfaces for abrasion.

As seen in FIG. 9, which shows another modified embodiment of an agitator 1h, wing-shaped elements 11 are attached on the inside edge of the agitator blades 3h, with the wing-shaped elements 11 being oriented substantially perpendicular to the radial span of the agitator blades 3h and having a corresponding length b. These wing-shaped elements 11 prevent flow around the agitator blades 3h which causes adverse vortex characteristics.

Although different, separate changes in the geometry of support disk 2a to 2h and/or changes in the design geometry of the agitator blades 3a to 3h were described above with reference to FIGS. 2 to 9, these measures can also be combined, depending on the desired application and the actual situation. The invention is therefore not limited to the features and details described above with reference to the preferred embodiments illustrated in FIGS. 2 to 9, but combinations thereof are possible, which are suitable for effectively and permanently reducing wear on those sides of the agitator blades 3a to 3h that face away from the flow, and/or on the support disk 2a to 2h in the region where the blades are attached. The agitators 3a to 3h are configured so as to prevent vortex formation and a resulting impact and sliding wear, in particular in the trailing region of the agitator blades 3a to 3h and at those locations where the agitator blades 3a to 3h are attached to the support disk 2a to 2h.

1.-10. (canceled)

11. An agitator, in particular for abrasive media, comprising:
a support disk defining a radial direction and an axial direction;
a plurality of agitator blades attached to the support disk substantially in the axial and radial direction; and
a hub for receiving an agitator shaft,
wherein sides of the agitator blades or a region where the agitator blades are attached to the support disk, or both, are constructed substantially in the absence of vortex shedding.

12. The agitator of claim 11, wherein the agitator blades have a pitch angle with respect to the radial direction from about 10° to 60°.

13. The agitator of claim 11, wherein the agitator blades have a pitch angle with respect to the radial direction from about 20° to 50°.

14. The agitator of claim 11, wherein the agitator blades are constructed substantially in the absence of vortex shedding.

15. The agitator of claim 11, wherein the agitator blade have in the region where the blades are attached to the support disk a radius, with the radius facing the flow direction.

16. The agitator of claim 15, wherein the radius has a value of between 0.1 and 1.0 times a diameter of the agitator.

17. The agitator of claim 11, wherein one side of the agitator blades is attached on the support disk.

18. The agitator of claim 11, wherein the support disk is configured in the region where the agitator blades are attached to the support disk substantially in the absence of vortex shedding.

19. The agitator of claim 11, wherein the support disk comprises several support disk parts.

20. The agitator of claim 11, wherein the support disk has a recess on the side of the agitator blades that faces away from flow.

21. The agitator of claim 11, wherein the agitator blades further comprise wing-shaped elements that are arranged on an inside edge of the agitator blades.

22. The agitator of claim 11, wherein the agitator blades are at least partially coated with an abrasion-resistant material at locations which are at risk of being abraded.
